(19) United States
(12) Patent Application Publication
(10) Pub. No.: US 2026/0081519 A1
(43) Pub. Date: Mar. 19, 2026

(54) METHODS, APPARATUSES, AND SYSTEMS FOR DISCHARGING ELECTRONIC DEVICES

(71) Applicant: Robert Bosch GmbH, Stuttgart (DE)

(72) Inventors: Ni Zhang, Wuxi (CN); Hengqi Shui, Wuxi (CN); Honglu Wang, Wuxi (CN)

(21) Appl. No.: 19/331,065

(22) Filed: Sep. 17, 2025

(30) Foreign Application Priority Data
Sep. 18, 2024 (CN) 2024 1129 8819.0

(51) Int. Cl. H02M 1/32; H02M 1/08; H02M 3/158

(52) U.S. Cl. CPC H02M 1/322; H02M 1/08; H02M 3/1582

(57) ABSTRACT

Methods, apparatuses, and systems for discharging electronic devices are disclosed. The discharge loop of the electronic device includes an energy storage device and a discharge circuit connected in parallel with the energy storage device. The driver circuit of the discharge switch tube of the discharge circuit has a circuit structure with adjustable driving resistance. In response to receiving a discharge enable command, the circuit structure of the driver circuit of the discharge switch tube is adjusted so that the driving resistance is increased, and the driver circuit is enabled to drive the discharge switch tube to discharge the energy storage device until the terminal voltage of the energy storage device is discharged to a predetermined voltage value. Since the driving resistance of the driver circuit increases during discharge, the switching loss of the discharge switch tube will also increase, so that rapid discharge of the energy storage device can be achieved without using a discharge circuit implemented based on a discharge resistor.

This application claims priority under 35 U.S.C. § 119 to application no. CN 2024 1129 8819.0, filed on Sep. 18, 2024 in China, the disclosure of which is incorporated herein by reference in its entirety.

Embodiments of the present specification relate generally to the field of electrical control, and more particularly, to methods, apparatuses, and systems for discharging electronic devices.

### BACKGROUND

For electronic devices with energy storage circuits, in order to ensure the safety of the electronic device when, e.g., the voltage of the energy storage circuit exceeds a predetermined voltage threshold, an active discharge function needs to be set in the electronic device to actively discharge the energy storage circuit. For example, in a hybrid vehicle (HV) such as a fuel cell vehicle, an active discharge function needs to be provided for the hybrid vehicle for hybrid mode safety.

In existing active discharge implementation solutions, discharge is typically carried out using a discharge resistor through a discharge circuit implemented based on a discharge resistor. In a discharge solution based on a discharge resistor, the discharge path usually consists of a discharge resistor and a switch connected in series. The energy of the discharge component is entirely consumed by the heat generated by the discharge resistor, making the discharge resistor susceptible to damage after multiple discharges, thereby limiting the service life of the discharge circuit. Moreover, such a discharge solution requires additional components and control circuitry and, due to the greater energy released by the discharge, requires a greater volume of discharge resistor, which will result in more equipment costs and device space usage. In addition, the operating frequency is limited due to the temperature characteristics of the discharge resistor. After active discharge is complete, the discharge resistor usually takes a long time to cool. In exceptional cases, additional heat dissipation components are also needed to cool the discharge resistor, further increasing device costs. Furthermore, such a discharge solution is less compatible with different topologies. For example, in a buck-boost topology, two sets of discharge circuits are even needed to release energy at the input side and output side, respectively. Moreover, when an electronic device has multiple energy storage devices at different locations, the energy storage devices at different locations may have different discharge requirements. For example, when the electronic device has a buck-boost circuit, both the input and output ends of the buck-boost circuit have energy storage capacitors. Since the voltage values on the energy storage capacitors at the input and output ends are different, the discharge requirements of the energy storage capacitors at the input and output ends will also be different. In this case, independent discharge is needed for the energy storage devices at different locations.

### SUMMARY

The following introduction is provided in order to introduce selected concepts in a simple manner, and these concepts will be further described in the detailed description below. The introduction is not intended to highlight the key or necessary features of the claimed subject matter, nor is it intended to limit the scope of the claimed subject matter.

According to one aspect of examples of the present specification, a method for discharging an electronic device is provided, the discharge loop of the electronic device comprising an energy storage device and a discharge circuit connected in parallel with the energy storage device, the discharge circuit comprising a discharge switch tube, and the driver circuit of the discharge switch tube having a circuit structure with adjustable driving resistance. The method comprises: in response to receiving a discharge enable command, adjusting the circuit structure of the driver circuit so that the driving resistance is increased; and enabling the driver circuit with increased driving resistance to drive the discharge switch tube to discharge the energy storage device until the terminal voltage of the energy storage device is discharged to a predetermined voltage value.

According to another aspect of examples of the present specification, an apparatus for discharging an electronic device is provided, the discharge loop of the electronic device comprising an energy storage device and a discharge circuit connected in parallel with the energy storage device, the discharge circuit comprising a discharge switch tube, and the driver circuit of the discharge switch tube having a circuit structure with adjustable driving resistance. The apparatus comprises: at least one processor; a memory coupled with the at least one processor; and a computer program stored in the memory, the at least one processor executing the computer program to implement the method for discharging an electronic device as described above.

According to another aspect of examples of the present specification, a system for discharging an electronic device is provided, comprising: an electronic device, comprising at least one discharge loop comprising an energy storage device and a discharge circuit connected in parallel with the energy storage device, the discharge circuit comprising a discharge switch tube, and the driver circuit of the discharge switch tube having a circuit structure with adjustable driving resistance; and an apparatus for discharging the electronic device as described above.

By utilizing the discharge control solution according to the examples of the present specification, the driver circuit of the discharge circuit implemented based on the switch tube is set to a circuit structure with adjustable driving resistance, and the circuit structure of the driver circuit is adjusted during discharge to increase the driving resistance, thereby improving the switching loss of the discharge switch tube and achieving rapid discharge of the energy storage device without additionally setting up a discharge circuit implemented based on a discharge resistor.

Furthermore, when the electronic device has at least two discharge loops, independent discharge of the energy storage device in the first discharge loop can be achieved by controlling the first discharge loop to be discharged and the energy storage devices of the remaining discharge loops to form no path after receiving an enable command.

### BRIEF DESCRIPTION OF THE DRAWINGS

The nature and advantages of the examples of the present specification may be further implemented by referring to the following accompanying drawings. In the drawings, similar components or features may have the same reference signs.

FIG. 1 shows an exemplary framework diagram of a system for discharging an electronic device according to examples of the present specification.

FIG. 2 shows an exemplary schematic diagram of an equivalent circuit diagram of an implementation example of a driver circuit according to examples of the present specification.

FIG. 3 shows an exemplary schematic diagram of a discharge loop for an electronic device according to examples of the present specification.

FIG. 4 shows an exemplary flow chart of a method for discharging an electronic device according to examples of the present specification.

FIG. 5 shows an exemplary framework diagram of an apparatus for discharging an electronic device according to examples of the present specification.

FIG. 6 shows another exemplary schematic diagram of a discharge loop for an electronic device according to examples of the present specification.

FIG. 7 shows another exemplary flow chart of a method for discharging an electronic device according to examples of the present specification.

FIG. 8A shows an exemplary schematic diagram of the gate level of the switch tube when the input end is discharging according to examples of the present specification.

FIG. 8B shows an exemplary schematic diagram of the gate level of the switch tube when the output end is discharging according to examples of the present specification.

FIG. 9 shows an exemplary schematic diagram of a discharge control apparatus implemented based on a computer system according to examples of the present specification.

### TEXT DESCRIPTION OF DRAWINGS

100 Discharge system
110 Electronic device
120 Discharge control apparatus
130 Network
300 Discharge loop
310 Energy storage capacitor
320 Driver circuit
330 Discharge switch tube
400 Method for discharging an electronic device
410 In response to receiving the discharge enable command, the circuit structure of the driver circuit of the discharge switch tube is adjusted so that the driving resistance is increased
420 The driver circuit is enabled to drive the discharge switch tube to discharge the energy storage device until the terminal voltage of the energy storage device is discharged to a predetermined voltage value
500 Discharge control apparatus
510 Circuit connection relationship control unit
520 Driver circuit control unit
601 Input end capacitor 602 Input end upper switch tube
603 Input end lower switch tube
604 Input end upper switch tube driver circuit
605 Input end lower switch tube driver circuit
606 Output end upper switch tube
607 Output end lower switch tube
608 Output end upper switch tube driver circuit
609 Output end lower switch tube driver circuit
610 Output end capacitor
700 Method for discharging an electronic device
710 In response to receiving the discharge enable command, the first discharge loop is controlled to form no path between the energy storage devices of the remaining discharge loops
720 The circuit structure of the driver circuit of the discharge switch tube in the first discharge loop is adjusted so that the driving resistance increases
730 The driver circuit is enabled to drive the discharge switch tube to discharge the energy storage device until the terminal voltage of the energy storage device is discharged to a predetermined voltage value
900 Discharge control apparatus
910 Processor
920 Memory
930 RAM
940 Communication Interface
960 Bus

### DETAILED DESCRIPTION

The subject matter described herein will now be discussed with reference to exemplary embodiments. It should be understood that discussions about these embodiments are provided to aid those skilled in the art in better understanding and thereby implementing the subject matter described herein rather than limiting the scope of protection, applicability, or examples described in the patent claims. Changes may be made to the functions and arrangements of the elements discussed without departing from the scope of protection of the content of the present disclosure. Various processes or components may be omitted, substituted, or added in the various examples as needed. For example, the described method may be performed in a different order than that described, and various steps may be added, omitted, or combined. In addition, features described in relation to some examples may also be combined in other examples.

As used herein, the term “comprising” and its variations are open terms, which mean “including but not limited to”. The term “based on” indicates “at least partially based on”. The terms “one example” and “an example” indicate “at least one example”. The term “another example” indicates “at least one other example”. The terms “first”, “second”, etc. may refer to different or same objects. Other definitions, whether explicit or implied, may be included below. Unless explicitly stated in the context, the definition of one term is consistent throughout the description.

FIG. 1 shows an exemplary framework diagram of a system for discharging an electronic device (hereinafter referred to as a discharge system) 100 according to examples of the present specification.

As shown in FIG. 1, the discharge system 100 comprises an electronic device 110 and a discharge control apparatus 120. The electronic device 110 and the discharge control apparatus 120 may communicate with each other via the network 130 to transmit data. In some examples, the network 130 may be any one or more of a wired or wireless network. Examples of the network 130 may include, but are not limited to, cable networks, fiber optic networks, telecommunications networks, intranet, the Internet, local area networks (LANs), wide area networks (WANs), wireless local area networks (WLANs), metropolitan area networks (MANs), public switched telephone networks (PSTNs), Bluetooth networks, Zigbee networks, near field communications (NFCs), in-device buses, in-device lines, etc. or any combination thereof. In some examples, the electronic device 110 and the discharge control apparatus 120 may communicate directly without the need for the network 130. Alternatively, the discharge control apparatus 120 may be integrated in the electronic device 110.

The electronic device 110 may have one or more energy storage devices to be discharged. Each energy storage device has an independent discharge circuit and is connected in parallel with the corresponding discharge circuit to form a discharge loop. Examples of energy storage devices may include, e.g., energy storage capacitors, other types of capacitive devices, other types of energy storage devices, etc. The discharge circuit comprises a driver circuit and a discharge switch tube, and the driver circuit and the discharge switch tube are connected in series to drive the discharge switch tube to discharge the energy storage device. Examples of discharge switch tubes may include, but are not limited to, various types of field effect tubes, transistors, triodes, etc. For example, when the discharge switch tube is implemented as a field effect tube, the driver circuit may be connected in series with the gate of the switch tube. The driver circuit may have a circuit structure in which the driving resistance is adjustable. For example, the circuit structure of the driver circuit may be adjusted such that the driving resistance of the driver circuit is increased.

The driving resistance of the switch tube directly affects the switching speed of the switch tube. When the driving resistance is too large, the charging and discharging speed of the gate capacitance slows down, resulting in a decrease in the switching speed of the switch tube and an increase in switching time, thereby increasing the energy loss in the switching process and potentially reducing the overall efficiency of the circuit. In contrast, too little driving resistance can increase the charging and discharge speed of the gate capacitance, increase the switching speed of the switch tube, and shorten the switching time, but may also cause the driver circuit to oscillate, increasing additional losses.

In some examples, the circuit structure of the driver circuit may be set such that in a non-discharge working state such as voltage modulation, the size of the driving resistance ensures that the switching loss is as low as possible and does not cause oscillation of the driver circuit; in a discharge working state, the driving resistance becomes larger and ensures that the switching voltage of the switch tube reaches a level range in which the switch tube can be reliably turned on. For example, the resistance adjustment change value/change ratio of the driving resistance of the driver circuit can be selected according to the switch tube characteristics of the switch tube used.

In some examples, the driver circuit may be provided with a discharge control resistor with an adjustable circuit connection state, and the discharge control resistor is set in parallel with the first circuit structure corresponding to some or all of the remaining resistive devices of the driver circuit. During discharging, the parallel connection between the discharge control resistor and the first circuit structure is disconnected, thereby increasing the driving resistance of the driver circuit. In some examples, the discharge control resistor may be connected in series with a switching device and the switching device connected in series may be used to control the parallel connection and disconnection with the first circuit structure. In this driver circuit configuration, the driver circuit may be controlled to have two circuit connection states. When not discharging, the control driver circuit has a first circuit connection state in which the discharge control resistor is connected in parallel with the first circuit structure, and when discharging, the control driver circuit has a second circuit connection state in which the discharge control resistor is disconnected from the first circuit structure. In the present specification, the discharge control resistor is used to refer to a resistor that can be used to adjust the resistance value of the driving resistance of the driver circuit of the discharge switch tube, thereby adjusting the switching loss of the discharge switch tube during discharge.

In some examples, the driving resistance in the driver circuit may be implemented by an adjustable resistor with an adjustable resistance value. During discharge, the driving resistance of the driver circuit is increased by increasing the resistance value of the adjustable resistor. In other examples, the driver circuit may also be implemented using other adjustable driving resistance mechanisms known in the art.

In some examples, the discharge circuit in the discharge loop can be implemented by reusing a switch tube circuit in an electronic device that is connected in parallel with the energy storage device to realize other functions. The switch tube circuit comprises at least one switch tube and the first circuit structure corresponding to some or all of the resistive devices of the driver circuit of the discharge switch tube used for discharge in the at least one switch tube is provided in parallel with a discharge control resistor with an adjustable circuit connection state. For example, in electronic devices with a buck-boost circuit, when discharging the input end capacitor and the output end capacitor of the buck-boost circuit, the switch tube circuit and the driver circuit of the switch tube circuit (i.e., the input end switch tube circuit) connected in parallel with the input end capacitor at the input end of the buck-boost circuit can be reused as the discharge circuit of the input end discharge loop, and the switch tube circuit and the driver circuit of the switch tube circuit (i.e., the output end switch tube circuit) connected in parallel with the output end capacitor at the output end of the buck-boost circuit can be reused as the discharge circuit of the output end discharge loop, thereby reducing circuit costs and circuit space occupancy.

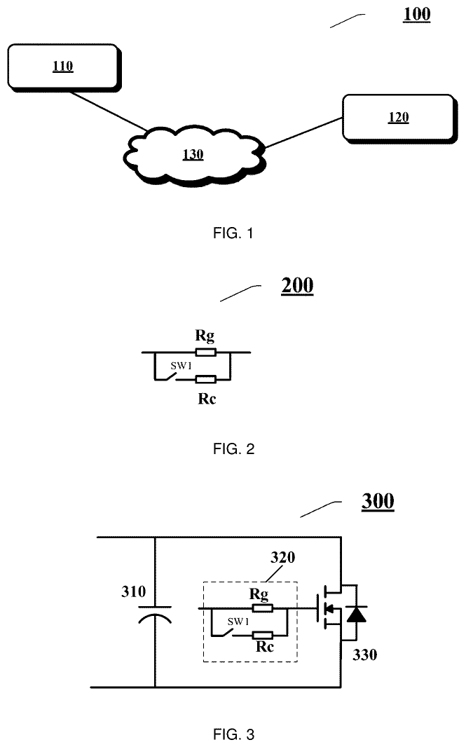

FIG. 2 shows an exemplary schematic diagram of an equivalent circuit diagram of an implementation example of a driver circuit according to examples of the present specification. In the example of FIG. 2, the equivalent resistance R_{g} is equivalent to the equivalent resistance of the first circuit structure corresponding to some or all of the remaining resistive devices of the driver circuit of the discharge switch tube, or to the equivalent resistance of the first circuit structure corresponding to some or all of the resistive devices of the driver circuit of the discharge switch tube in the reused switch tube circuit. The resistor R_{c} is equivalent to a discharge control resistor arranged in parallel and is connected in parallel with and disconnected from the first circuit structure through the series-connected switching device SW1.

The discharge control apparatus 120, in response to receiving the discharge enable command, adjusts the circuit structure of the driver circuit such that the driving resistance is increased and causes the driver circuit to drive the discharge switch tube to discharge the stored energy in the electronic device.

The method and apparatus for discharging an electronic device according to the examples of this specification will be described in detail below with reference to the accompanying drawings.

FIG. 3 shows an exemplary schematic diagram of a discharge loop 300 for an electronic device in accordance with examples of the present specification. An electronic device with a single discharge loop is shown in the example of FIG. 3.

As shown in FIG. 3, the discharge loop 300 comprises a capacitor 310, a driver circuit 320, and a discharge switch tube 330. The capacitor 310 acts as an energy storage device for the electronic device. The driver circuit 320 and the discharge switch tube 330 (e.g., the gate of the discharge switch tube 330) are connected in series to drive the discharge switch tube 330 to operate and the driver circuit 320 and the discharge switch tube 330 form a discharge circuit of the capacitor 310. The capacitor 310 is connected in parallel with the corresponding discharge circuit to form a discharge loop of the capacitor 310.

From an equivalent resistance perspective, the driver circuit 320 may be equivalent to being composed of an equivalent resistor R_{g} and a discharge control resistor R_{c} connected in parallel with the switching device SW1 in series. The equivalent resistance R_{g} is equivalent to the equivalent resistance of the first circuit structure corresponding to all remaining resistive devices in the driver circuit 320. In some examples, the driver circuit 320 and the discharge switch tube 330 can be implemented by reusing a switch tube circuit of the electronic device that is connected in parallel with the capacitor 310 and is used to implement other functions. In this case, the equivalent resistance R_{g} is equivalent to the equivalent resistance of the circuit structure corresponding to the driver circuit of the switch tube serving as the discharge switch tube in the reused switch tube circuit.

The discharge control apparatus may be communicatively coupled with the driver circuit in the discharge circuit of the discharge loop 300. In response to receiving the discharge enable command, the switch SW1 and the driver circuit are controlled to drive the discharge switch tube 330 to operate to discharge the capacitor 310.

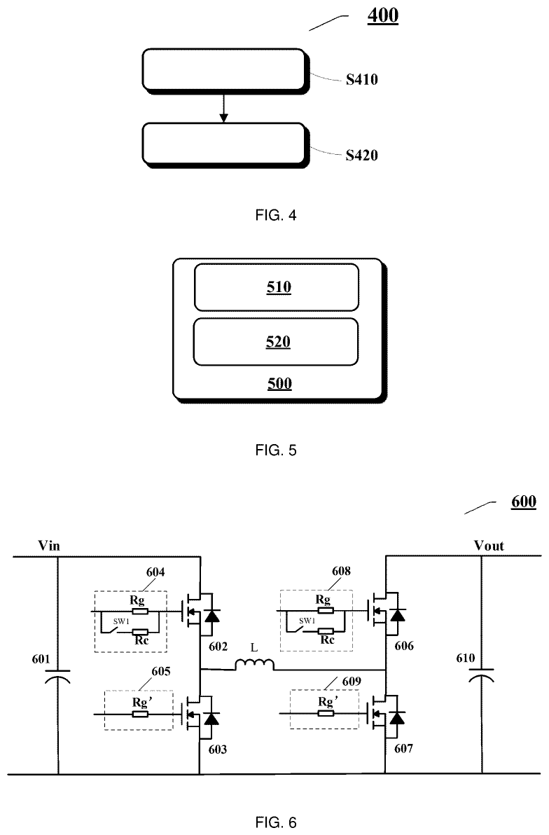

FIG. 4 shows an exemplary flow chart of a method 400 for discharging an electronic device according to examples of the present specification. FIG. 4 shows an example of a discharge method for an electronic device with a single discharge loop.

As shown in FIG. 4, at S410, in response to receiving the discharge enable command, the circuit structure of the driver circuit is adjusted such that the driving resistance is increased.

In some examples, the driver circuit is provided with a discharge control resistor with an adjustable circuit connection state, and the discharge control resistor is set in parallel with the first circuit structure corresponding to some or all of the remaining resistive devices of the driver circuit. In this instance, in response to receiving the discharge enable command, the circuit connection relationship between the discharge control resistor and the first circuit structure is adjusted from a parallel state to a disconnected state, thereby increasing the driving resistance of the driver circuit.

After completing the circuit structure adjustment of the driver circuit, at S420, the driver circuit is enabled to drive the discharge switch tube to discharge the energy storage device until the terminal voltage of the energy storage device is discharged to a predetermined voltage value.

In some examples, the discharge control apparatus causes the driver circuit to drive the discharge switch tube to discharge the energy storage device in a pulse width modulation (PWM) control manner until the terminal voltage of the energy storage device reaches a predetermined voltage value, e.g., below the safety voltage.

In accordance with the above discharge method, since the driving resistance of the driver circuit increases during discharge, the switching loss of the discharge switch tube during operation will also increase, thereby accelerating the discharge process of the energy storage device.

FIG. 5 shows an exemplary framework diagram of an apparatus for discharging an electronic device (hereinafter referred to as a discharge control apparatus) 500 according to examples of the present specification. As shown in FIG. 5, the discharge control apparatus 500 comprises a circuit connection relationship control unit 510 and a driver circuit control unit 520.

The circuit connection relationship control unit 510 is configured to adjust the circuit structure of the driver circuit of the discharge switch tube so as to increase the driving resistance in response to receiving the discharge enable command.

In some examples, the driver circuit is provided with a discharge control resistor with an adjustable circuit connection state, and the discharge control resistor is set in parallel with the first circuit structure corresponding to some or all of the remaining resistive devices of the driver circuit. In this instance, in response to receiving the discharge enable command, the circuit connection relationship control unit 510 controls the circuit connection relationship between the discharge control resistor and the first circuit structure to be adjusted from a parallel state to a disconnected state, thereby increasing the driving resistance of the driver circuit of the discharge switch tube.

The driver circuit control unit 520 is configured to enable the driver circuit to drive the discharge switch tube to discharge the energy storage device until the terminal voltage of the energy storage device is discharged to a predetermined voltage value.

FIG. 6 shows another exemplary schematic diagram of a discharge loop 600 for an electronic device in accordance with examples of the present specification. In the example of FIG. 6, the electronic device has a buck-boost circuit (four-switch buck-boost) and at least two discharge loops. For example, an input end discharge circuit is obtained by reusing an input end switch tube circuit connected in parallel with an input end capacitor to be discharged at the input end of the buck-boost circuit, thereby forming an input discharge loop with the input end capacitor, and an output end discharge circuit is obtained by reusing an output end switch tube circuit connected in parallel with an output end capacitor to be discharged at the output end of the buck-boost circuit, thereby forming an output discharge loop with the output end capacitor.

As shown in FIG. 6, the input end discharge loop comprises an input end discharge circuit in parallel with an input end energy storage device (input end capacitor) 601. The input end discharge circuit comprises an input end upper switch tube 602 and an input end lower switch tube 603 connected in series with each other, and the input end upper switch tube 602 serves as a discharge switch tube in the input end discharge loop. The gates of the input end upper switch tube 602 and the input end lower switch tube 603 are connected in series with driver circuits 604 and 605, respectively. The driver circuit 604 has a circuit structure in which the driving resistance is adjustable, and the driver circuit 605 has a circuit structure in which the driving resistance is not adjustable. The driver circuit 604 is provided with a discharge control resistor R_{c} with an adjustable circuit connection state, and the discharge control resistor R_{c} is configured to be connected in series with the switching device SW1 and then in parallel with a first circuit structure (equivalent resistor R_{g}) corresponding to some or all of the remaining resistive devices in the driver circuit 604, thereby adjusting the circuit connection state of the discharge control resistor through the switching device SW1. The driver circuit 605 has an equivalent resistance R_{g′}.

The output end discharge loop comprises an output end discharge circuit connected in parallel with an output end energy storage device (output end capacitor) 610. The output end discharge circuit comprises an output end upper switch tube 606 and an output end lower switch tube 607 connected in series with each other, and the output end upper switch tube 607 serves as a discharge switch tube in the output end discharge loop. The gates of the output end upper switch tube 606 and the output end lower switch tube 607 are connected in series with driver circuits 608 and 609, respectively. The driver circuit 608 has a circuit structure in which the driving resistance is adjustable, and the driver circuit 609 has a circuit structure in which the driving resistance is not adjustable. The driver circuit 608 is provided with a discharge control resistor R_{c} with an adjustable circuit connection state, and the discharge control resistor R_{g} is configured to be connected in series with the switching device SW1 and then in parallel with a first circuit structure (equivalent resistor R_{g}) corresponding to some or all of the remaining resistive devices in the driver circuit 608, thereby adjusting the circuit connection state of the discharge control resistor through the switching device SW1. The driver circuit 607 has an equivalent resistance R_{g′}.

The input end upper switch tube and the input end lower switch tube are connected to the output end upper switch tube and the output end lower switch tube via the midpoint of the inductive device

In the four-switch buck-boost circuit shown in FIG. 6, the circuit structure comprising the input end switching circuit (the input end upper switch tube 602 and the input end lower switch tube 603 connected in series), the output end switching circuit (the output end upper switch tube 606 and the output end lower switch tube 607 connected in series), and the inductive device L inherently functions to control the output voltage using the switching periodicity of the switching circuit. That is, the switch tube of the switching circuit is used to periodically connect or disconnect the input power supply and the output load so as to reasonably control the on and off time of the switch tube in the switching circuit by adjusting the switching state and switching cycle, thereby achieving effective regulation of the input voltage and achieving the purpose of voltage decrease and voltage increase. For example, when the switch tubes 602 and 607 are simultaneously turned on, the switch tubes 603 and 606 are turned off, so that the input side power supply transfers energy to the inductor and the energy is stored through the inductor. When the switch tubes 602 and 607 are simultaneously turned off, the switch tubes 603 and 606 are turned on (i.e., the switch tubes 603 and 606 function as synchronous rectifiers to improve efficiency) and the inductor transfers energy to the output side. In the present specification, the input end switch circuit is multiplexed to serve as the discharge circuit of the input end discharge loop, and the output end switching circuit is multiplexed to serve as the discharge circuit of the output end discharge loop.

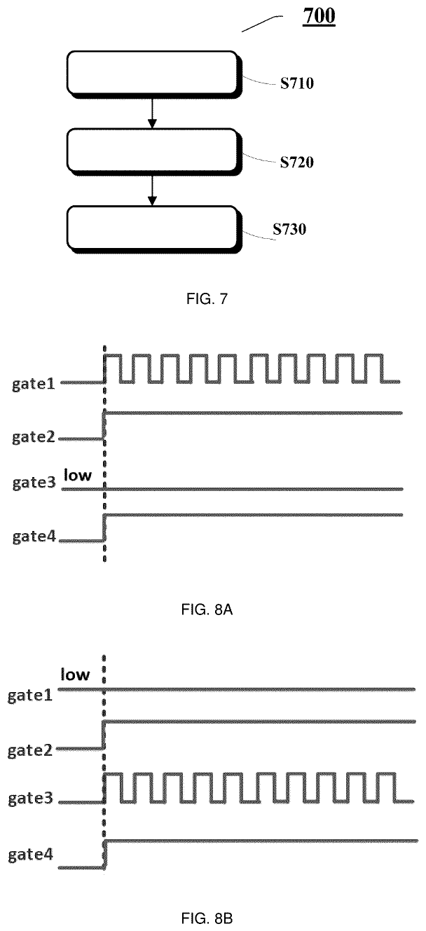

FIG. 7 shows another exemplary flow chart of a method 700 for discharging an electronic device according to examples of the present specification. In the example of FIG. 7, the electronic device has at least two discharge loops, e.g., an input end discharge loop and an output end discharge loop as shown in FIG. 6.

As shown in FIG. 7, at S710, in response to receiving a discharge enable command for a first discharge loop of an electronic device, no path is formed between the first discharge loop and the energy storage devices of the remaining discharge loops.

At S720 , the circuit structure of the driver circuit of the discharge switch tube in the first discharge loop is adjusted so that the driving resistance increases. For example, by controlling the switching device SW1 in the driver circuit of the discharge switch tube in the first discharge loop to be disconnected during discharge, the parallel connection between the discharge control resistor and the first circuit structure corresponding to the remaining resistive devices in the driver circuit of the discharge switch tube is disconnected, thereby increasing the driving resistance of the driver circuit of the discharge switch tube in the first discharge loop.

At S730, the driver circuit of the discharge switch tube in the first discharge loop is enabled to drive the discharge switch tube in the first discharge loop to discharge the energy storage device in the first discharge loop until the terminal voltage of the energy storage device in the first discharge loop is discharged to a predetermined voltage value (e.g., the safety voltage).

For example, for the input end and output end discharge loops shown in FIG. 6, in response to receiving input end or output end discharge enable commands, the upper switch tube at the local end is controlled to operate according to a pulse width modulation control method to discharge the energy storage device at the local end, while the lower switch tube at the local end and the lower switch tube at the opposite end remain in a continuously on state, and the upper switch tube at the opposite end remains in a continuously off state.

FIG. 8A shows an exemplary schematic diagram of the gate level of the switch tube when the input end is discharging according to examples of the present specification.

After receiving the discharge enable command for the input end discharge loop, the switching device SW1 in the driver circuit 604 of the input end upper switch tube 602 is controlled to be disconnected, thereby disconnecting the parallel connection between the discharge control resistor R_{c} and the equivalent resistor R_{g}, increasing the driving resistance of the driver circuit 604 from (R_{g}*R_{c})/(R_{g}+R_{c}) to R_{g}, and increasing the driving resistance of the driver circuit 604.

Subsequently, gate levels are provided to the gates of the switch tubes at the input and output ends according to the control method shown in FIG. 8A, thereby achieving operation control of the switch tubes at the input and output ends. As shown in FIG. 8A, a pulse width modulation voltage waveform is provided to the input end upper switch tube 602, such that the input end upper switch tube 602 is operating under pulse width modulation control to discharge the input end capacitor 601 until the terminal voltage of the input end capacitor 601 discharges to a predetermined voltage value, such as the safety voltage. A high level is provided for the input end lower switch tube 603 and the output end lower switch tube 607 such that the input end lower switch tube 603 and output end lower switch tube 607 remain in a continuous turned-on state. A low level is provided for the output end upper switch tube 606 such that the output end upper switch tube 606 remains in a continuously cut-off state, thereby allowing for no path to be formed between the input end discharge loop and the output end capacitor 610.

FIG. 8B shows an exemplary schematic diagram of the gate level of the switch tube when the output end is discharging according to examples of the present specification.

After receiving the discharge enable command for the output end discharge loop, the switching device SW1 in the driver circuit 608 of the output end upper switch tube 606 is controlled to be disconnected, thereby disconnecting the parallel connection between the discharge control resistor and the equivalent resistor, increasing the driving resistance of the driver circuit 608 from (R_{g}*R_{c})/(R_{g}+R_{c}) to R_{g}, and increasing the driving resistance of the driver circuit 608.

Subsequently, gate levels are provided to the gates of the switch tubes at the input and output ends according to the control method shown in FIG. 8B, thereby achieving operation control of the switch tubes at the input and output ends. As shown in FIG. 8B, a pulse width modulation voltage waveform is provided to the output end upper switch tube 606, such that the output end upper switch tube 606 is operating under pulse width modulation control to discharge the output end capacitor 610 until the terminal voltage of the output end capacitor 610 discharges to a predetermined voltage value, such as the safety voltage. A high level is provided for the input end lower switch tube 603 and the output end lower switch tube 607 such that the input end lower switch tube 603 and output end lower switch tube 607 remain in a continuous turned-on state. A low level is provided for the input end upper switch tube 602 such that the input end upper switch tube 602 remains in a continuously cut-off state, thereby allowing for no path to be formed between the output end discharge loop and the input end capacitor 601.

In examples of discharge control for an electronic device with at least two discharge loops, the discharge control apparatus shown in FIG. 5 may be modified to implement discharge control for an electronic device with at least two discharge loops. In particular, the discharge control apparatus for an electronic device with at least two discharge loops may have the circuit structure shown in FIG. 5, but the functions implemented by the circuit connection relationship control unit need to be modified. In this example, in response to receiving a discharge enable command for a first discharge loop in an electronic device, a path is controlled not to be formed between the first discharge loop and the energy storage devices of the remaining discharge loops in the electronic device, and the circuit structure of the driver circuit of the discharge switch tube in the first discharge loop is adjusted so that the driving resistance is increased.

According to the above discharge control method, when the electronic device has at least two discharge loops, by controlling the first discharge loop to be discharged to form no path between the energy storage devices of the remaining discharge loops after receiving an enable command, independent discharge of the energy storage devices in the first discharge loops can be achieved, thereby improving the flexibility and independence of discharging energy storage devices at different positions in the electronic device and meeting the different discharge requirements of energy storage devices at different positions in the electronic device.

As described above with reference to FIGS. 1 to 8B, a method for discharging an electronic device, a discharge control apparatus, and a system for discharging an electronic device according to examples of the present specification are described. The above discharge control apparatus may be implemented using hardware or software or a combination of hardware and software.

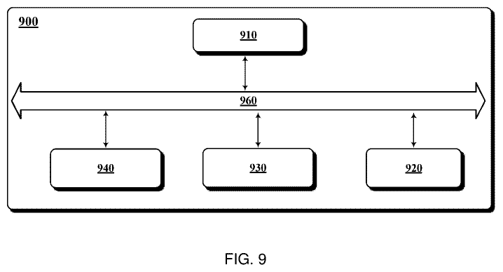

FIG. 9 shows an exemplary schematic diagram of a discharge control apparatus 900 implemented based on a computer system according to examples of the present specification. As shown in FIG. 9, the discharge control apparatus 900 may comprise at least one processor 910, a memory (e.g., a non-volatile memory) 920, RAM 930, and a communication interface 940, and the at least one processor 910, memory 920, RAM 930, and communication interface 940 are connected together via a bus 960. The at least one processor 910 executes at least one computer-readable instruction stored or encoded in the memory (i.e., the elements described above implemented in software).

In one example, the computer-executable instructions are stored in the memory, which, when executed, cause at least one processor 910 to: in response to receiving a discharge enable command, control the circuit connection relationship between the discharge control resistor in the driver circuit of the discharge switch tube in the discharge loop and other resistive devices in the driver circuit to be adjusted from a parallel state to a disconnected state; and enable the driver circuit to drive the discharge switch tube to operate to discharge the energy storage device in the discharge loop until the terminal voltage of the energy storage device is discharged to a predetermined voltage value.

It should be understood that the computer-executable instructions stored in the memory, when executed, cause the at least one processor 910 to perform the various operations and functions described above in conjunction with FIGS. 1-8B in various examples of the present specification.

According to one example, a program product, such as a machine-readable medium (e.g., a non-transitory machine-readable medium), is provided. The machine-readable medium may have instructions (i.e., the elements described above implemented in software) that, when executed by the machine, cause the machine to perform the various operations and functions described above in conjunction with FIGS. 1-8B in various examples of the present specification. Specifically, a system or device equipped with a readable storage medium can be provided, on which software program code that implements the functions of any of the above examples are stored, and a computer or processor of the system or apparatus can read and execute instructions stored on the readable storage medium.

In this instance, the program code itself, read from the readable media, may provide for the functionality of any of the examples described above, so the machine-readable code and the readable storage media storing the machine-readable code form part of the present disclosure.

Examples of readable storage media include floppy disks, hard disks, magneto-optical disks, optical disks (e.g., CD-ROM, CD-R, CD-RW, DVD-ROM, DVD-RAM, and DVD-RW), magnetic tapes, non-volatile memory cards, and ROMs. Optionally, the program code may be downloaded from a server computer or the cloud by a communications network.

According to one example, a computer program product is provided that includes a computer program that, when executed by a processor, causes the processor to perform the various operations and functions described above in conjunction with FIGS. 1-8B in various examples of the present specification.

It will be appreciated by those skilled in the art that the various examples disclosed above can be variously varied and modified without departing from the essence of the disclosure. Accordingly, the protective scope of the present disclosure shall be defined by the appended patent claims.

It should be noted that not all steps and units in the above processes and system structure diagrams are necessary, and some steps or units can be ignored according to actual needs. The order in which the steps are performed is not fixed and can be determined as needed. The device structures described in the above-mentioned examples can be physical or logical structures. That is, some units may be realized by the same physical entity, while others may be realized by multiple physical entities or may be jointly realized by certain components in multiple separate devices.

In the above examples, the hardware units or modules may be implemented mechanically or electrically. For example, a hardware unit, module, or processor may include circuitry or logic (such as a dedicated processor, FPGA, or ASIC) that is permanently dedicated to complete the corresponding operations. The hardware unit or processor may also include programmable logic or circuitry (such as a general-purpose processor or other programmable processor) that may be temporarily set by the software to complete the corresponding operations. The specific implementation method (mechanical, dedicated permanent circuit, or temporary circuit) can be determined based on cost and time considerations.

Exemplary examples are described above with reference to the specific examples described in the accompanying drawings, but do not represent all examples that may be implemented or fall within the scope of protection of the patent claims. Throughout the present specification, the term “exemplary” means “serving as an example, instance, or illustration” and does not imply “preferred” or “advantageous” over other examples. Specific examples comprise specific details to facilitate understanding of the described technology. However, these technologies may be implemented without these specific details. In some instances, to avoid causing difficulties in understanding the concepts of the described examples, known structures and devices are shown in block diagram form.

The aforementioned description of the present disclosure is provided to allow any person of ordinary skill in the art to implement or use the present disclosure. Various modifications to the present disclosure will be apparent to those of ordinary skill in the art, and the general principles defined herein may be applied to other variations without departing from the scope of protection of the present disclosure. Therefore, the present disclosure is not limited to the exemplary examples and designs described herein but is consistent with the broadest scope defined by the principles and novel features disclosed herein.

What is claimed is:

1. A method for discharging an electronic device, wherein a discharge loop of the electronic device includes an energy storage device and a discharge circuit connected in parallel with the energy storage device, and wherein the discharge circuit includes a discharge switch tube, and further wherein a driver circuit of the discharge switch tube has a circuit structure with adjustable driving resistance, the method comprising:
in response to receiving a discharge enable command, adjusting the circuit structure of the driver circuit so that the driving resistance is increased; and
enabling the driver circuit with increased driving resistance to drive the discharge switch tube to discharge the energy storage device until a terminal voltage of the energy storage device is discharged to a predetermined voltage value.

2. The method of claim 1, wherein:
the driver circuit is provided with a discharge control resistor with an adjustable circuit connection state, and the discharge control resistor is set in parallel with the first circuit structure corresponding to some or all of the remaining resistive devices of the driver circuit, and
adjusting the circuit structure of the driver circuit so that the driving resistance is increased comprises controlling the circuit connection relationship between the discharge control resistor and the first circuit structure to be adjusted from a parallel state to a disconnected state.

3. The method of claim 2, wherein the discharge control resistor controls parallel connection and disconnection with the first circuit structure through a switching device connected in series.

4. The method of claim 1, wherein the discharge circuit is implemented by reusing a switch tube circuit in the electronic device that is connected in parallel with the energy storage devices to realize other functions, and a discharge control resistor with an adjustable circuit connection state is provided in parallel with the first circuit structure corresponding to some or all of the resistive devices of the driver circuits of the switch tubes serving as the discharge switch tubes in the switch tube circuit.

5. The method of claim 1, wherein the electronic device has at least two discharge loops, the discharge enable command comprises an independent discharge enable command for a first discharge loop of the at least two discharge loops,
and in response to receiving the discharge enable command, adjusting the circuit structure of the driver circuit so that the driving resistance is increased comprises:
in response to receiving a discharge enable command, controlling a path not to be formed between the first discharge loop and the energy storage devices of the remaining discharge loops, and adjusting the circuit structure of the driver circuit of the discharge switch tube in the first discharge loop so that the driving resistance is increased.

6. The method of claim 1, wherein enabling the driver circuit with increased driving resistance to drive the discharge switch tube to discharge the energy storage device until the terminal voltage of the energy storage device reaches a predetermined voltage value comprises:
in accordance with a pulse width modulation control method, enabling the driver circuit with increased driving resistance to drive the discharge switch tube to discharge the energy storage device until the terminal voltage of the energy storage device reaches a predetermined voltage value.

7. The method of claim 5, wherein the electronic device comprises a buck-boost circuit, and the at least two discharge loops comprise an input end discharge loop and an output end discharge loop of the buck-boost circuit, the discharge circuit of the input end discharge loop being implemented by reusing switch tube circuits at the input end that are connected in parallel with the input end energy storage device to implement other functions, and the discharge circuit of the output end discharge loop being implemented by reusing switch tube circuits at the output end that are connected in parallel with the output end energy storage device to implement other functions.

8. The method of claim 7, wherein the discharge circuit in the input end discharge loop comprises an input end upper switch tube and an input end lower switch tube connected in series with each other and the discharge circuit in the output end discharge loop comprises an output end upper switch tube and an output end lower switch tube connected in series with each other, the input end upper switch tube and the input end lower switch tube are connected to the output end upper switch tube and the output end lower switch tube via a midpoint of an inductive device, and the input end upper switch tube and the output end upper switch tube serve as discharge switch tubes in the input end discharge loop and the output end discharge loop, respectively,
wherein, in response to receiving the input end discharge enable command or the output end discharge enable command, the upper switch tube at the local end operates under the pulse width modulation control mode, the lower switch tube at the local end and the lower switch tube at the opposite end remain in a continuously on state, and the upper switch tube at the opposite end remains in a continuously off state.

9. An apparatus for discharging an electronic device, comprising:
at least one processor;
a memory coupled with the at least one processor; and
a computer program stored in the memory, the at least one processor executing the computer program to implement the method of claim 1.

10. A system for discharging an electronic device, comprising:
an electronic device comprising at least one discharge loop, the discharge loop comprising an energy storage device and a discharge circuit connected in parallel with the energy storage device, the discharge circuit comprising a discharge switch tube, and the driver circuit of the discharge switch tube having a circuit structure with adjustable driving resistance; and
the apparatus of claim 9.
